(19) United States
(12) Patent Application Publication
(10) Pub. No.: US 2024/0191113 A1
(43) Pub. Date: Jun. 13, 2024

(54) A BINDER COMPOSITION FREE OF PHENOL COMPOUND

(71) Applicant: UPM-KYMMENE CORPORATION, Helsinki (FI)

(72) Inventor: Sanna VALKONEN, Lappeenranta (FI)

(21) Appl. No.: 18/286,587

(22) PCT Filed: Apr. 15, 2021
(86) PCT No.: PCT/FI2021/050276

§ 371 Date: Oct. 12, 2023

(51) Int. Cl. C09J 197/00; B27D 1/04; C08H 7/00

(52) U.S. Cl. CPC C09J 197/005; C08H 6/00; B27D 1/04

(57) ABSTRACT

A method for producing a binder composition without using a compound selected from the class of phenols, is disclosed. The method comprises: (i) heating an aqueous composition comprising lignin and lignin oligomer in the presence of a catalyst at a temperature of 50-95° ° C. for 0.25-5 hours; (ii) mixing a cross-linking agent with the aqueous composition from (i) and heating the same at a temperature of 60-95° C. for polymerizing lignin, lignin oligomers, and cross-linking agent until a binder composition with a predetermined viscosity value is formed; wherein the molar ratio of crosslinking agent to lignin and lignin oligomer is 0.5-1.8.

### FIELD OF THE INVENTION

The invention relates to a method for producing a binder composition. Further, the invention relates to a binder composition, to an adhesive composition, and to the uses of the binder composition and the adhesive composition.

### BACKGROUND OF THE INVENTION

Lignin is natural polymer, which can be extracted from e.g. wood. The use of lignin as a component in glues instead of synthetic materials has been investigated in order to come up with a more environmentally friendly adhesive composition. Especially, the ability to replace synthetic phenol, derived from fossil sources, in final phenolic resins, such as phenol formaldehyde resin, has been the object of the investigations. However, the inventor has recognized the need for a method, which would result in a phenol free binder composition for further applications.

### SUMMARY

A method for producing a binder composition without using a compound selected from the class of phenols is disclosed. The method may comprise:
(i) heating an aqueous composition comprising lignin having a weight average molecular weight (Mw) of 2700-9000 g/mol and lignin oligomer having a weight average molecular weight (Mw) of 800-2500 g/mol in the presence of a catalyst at a temperature of 50-95° C. for 0.25-5 hours;
(ii) mixing a crosslinking agent with the aqueous composition from (i) and heating the same at a temperature of 60-95° C. for polymerizing lignin, lignin oligomers, and crosslinking agent until a binder composition with a predetermined viscosity value is formed;
wherein the molar ratio of crosslinking agent to lignin and lignin oligomer is 0.5-1.8.

Further is disclosed a binder composition obtainable by the method as defined in the current specification.

Further is disclosed an adhesive composition comprising the binder composition.

Further is disclosed the use of the binder composition in an impregnation application, for gluing a wood product or layered wood product or wood panel, for producing a laminate, shuttering film, mineral wool, nonwoven fiber product, molded fiber product, or extruded fiber product.

### DETAILED DESCRIPTION OF THE INVENTION

A method for producing a binder composition without using a compound selected from the class of phenols is disclosed. The method may comprise:
(i) heating an aqueous composition comprising lignin having a weight average molecular weight (Mw) of 2700-9000 g/mol and lignin oligomer having a weight average molecular weight (Mw) of 800-2500 g/mol in the presence of a catalyst at a temperature of 50-95 ºC for 0.25-5 hours;
(ii) mixing a crosslinking agent with the aqueous composition from (i) and heating the same at a temperature of 60-95 ºC for polymerizing lignin, lignin oligomers, and crosslinking agent until a binder composition with a predetermined viscosity value is formed;
wherein the molar ratio of crosslinking agent to lignin and lignin oligomer is 0.5-1.8.

Further is disclosed a binder composition obtainable by the method as defined in the current specification.

In one embodiment, the amount of free crosslinking agent, e.g. free formaldehyde monomers of the binder composition is at most 1 weight-%, or at most 0.5 weight-%, or at most 0.3 weight-%, or at most 0.1 weight-%, or at most 0.06 weight-%. The amount of free crosslinking agent, e.g. free formaldehyde may be determined in accordance with standard EN-ISO 11402 and hydroxylamine hydrochloride procedure with the exception that the sample is diluted in 20 ml of distilled water and 70 ml of 94% ethanol.

In one embodiment, the amount of free phenol of the binder composition is below 0.01 weight-% when determined by gas chromatography-flame ionization detector (GC-FID) method in accordance with standard SFS-EN ISO 8974:2002 with the exception that the alkaline sample solution is diluted before neutralization.

In one embodiment, the water miscibility (tolerance) of the binder composition is above 500%, or above 700%, or above 900%, or infinite, when determined in accordance with the standard EN ISO 8989.

In one embodiment, the viscosity value of the binder composition increases at most 400 cP/7 days, or at most 300 cP/7 days, or at most 200 cP/7 days, or at most 100 cP/7 days, when stored at 25° C. after its production. The binder composition as disclosed in the current specification has the added utility of showing a good storage stability.

The inventor surprisingly found out that the specified amount of crosslinking agent as well as the molar ratio of crosslinking agent to the polymerizing components, i.e. lignin and lignin oligomer, affects the properties of the produced binder composition such that a binder composition with the above properties may be prepared.

Further is disclosed an adhesive composition comprising the binder composition.

Further is disclosed the use of the binder composition in an impregnation application, for gluing a wood product or layered wood product or wood panel, for producing a laminate, shuttering film, mineral wool, nonwoven fiber product, molded fiber product, or extruded fiber product.

The product produced by using the binder composition as disclosed in the current specification may have one or more of the following properties:
the amount of formaldehyde emissions being 0.01-0.5 mg/l, or 0.1-0.3 mg/l when measured by desiccator method EN ISO 12460-4;
the amount of formaldehyde emissions being 0.01-0.40 mg/m2*h, or 0.05-0.30 mg/m2*h, or 0.1 0.2 mg/m2*h when measured by gas analysis EN ISO 12460-3;
fulfilling the minimum bonding class 1-4, or 2-4, or 3-4, or when measured by bonding quality test method EN 314-1 & EN314-2.

The inventor surprisingly found out that by the method as disclosed in the current specification, one is able to produce a binder composition without using any compound selected from the class of phenols.

In this specification, unless otherwise stated, the term “compound selected from the class of phenols” should be understood as meaning a fossil-based compound of phenols. I.e. phenols are compounds consisting of a single aromatic ring where to one or more hydroxyls (—OH) are bonded.

Such a compound selected from the class of phenols may be e.g. phenol, cresol, or resorcinol. Such phenols are toxic compounds. In one embodiment, the method comprises the proviso that no compound selected from the class of phenols is used for producing the binder composition. The method as disclosed in the current specification has the added utility of providing a manner to produce a binder composition free of materials of fossil origin. The binder composition produced may thus be free of fossil-based phenol compound(s). Especially the polymerizable substances used in the method, i.e. lignin and lignin oligomer, are of biomass or biological origin. The binder composition as disclosed in the current specification may thus prepared as a non-toxic binder composition. I.e. a binder composition with reduced share of toxic or hazardous compounds may be prepared. The binder composition as disclosed in the current specification may be prepared as 100% biological binder composition.

The total amount of crosslinking agent used for producing the binder composition may be 3 weight-%, or 4-8 weight-%, or 4-7 weight-%, or 5-7 weight-%, based on the total weight of the binder composition.

The “total weight” should in this specification be understood, unless otherwise stated, as the weight of both the dry matter and the liquid part, e.g. water, of the binder composition.

The method as disclosed in the current specification has the added utility of allowing a reduced or low amount of crosslinking agent, such as formaldehyde, to be used without affecting the properties of the formed binder composition in a harmful manner.

The crosslinking agent may be an aldehyde, such as formaldehyde or paraformaldehyde. In one embodiment, the aldehyde is prepared from bio-methanol. The aldehyde may thus be of biobased origin. The aldehyde may alternatively be of fossil origin. In one embodiment, the aldehyde is prepared from methanol.

The molar ratio of crosslinking agent to lignin and lignin oligomer may be 0.9-1.7, or 1.0-1.6, or 1.1-1.7, or 1.2-1.6. In the current specification, the molar ratio (MR) is calculated as follows:

MR=n(Fa)/(n(Lolig)+n(L))

wherein
n=the amount of substance in moles
Fa=crosslinking agent
Lolig=lignin oligomer
L=lignin

The amount of substance in moles are calculated as follows:

n=M/m

wherein
M=the molar mass of substance in g/mol
m=the mass of substance in grams

The following values are used for the above calculations in this specification:
M (oligomer)=180 g/mol (estimate based on literature and assumed chemical structure)
M (lignin)=180 g/mol (estimate based on literature and assumed chemical structure)

The weight ratio of lignin oligomer to lignin is 0.05-1.0, or 0.1-0.43, or 0.15-0.33.

The weight ratio of catalyst to lignin and lignin oligomer is 0.20-0.37, or 0.22-0.35, or 0.26-0.33. The molar ratio of catalyst to lignin and lignin oligomer is 1.0-1.7, or 1.1-1.6, or 1.2-1.5. The amount of catalyst may beneficially affect the properties of the produced binder composition.

The catalyst may comprise a salt or a hydroxide of an alkali metal or alkali earth metal. In one embodiment, the catalyst is selected from a group consisting of sodium hydroxide, potassium hydroxide, barium hydroxide, and their combinations. In one embodiment, the catalyst is sodium hydroxide.

The aqueous composition in step (i) may comprise or consist of or consist essentially of the lignin and lignin oligomer in the presence of a catalyst.

Step (i) may comprise heating the aqueous composition comprising lignin and lignin oligomer in the presence of a catalyst at a temperature of 50-95 ºC, or 55-95° C., or 60-95° C., or 65-90° C., or 70-85° C. Step (i) may be continued for 0.25-5 hours, or 2.5-4 hours, or 0.25-3 hours, or 0.5-2 hours, or 0.75-1.5 hours. During step (i) the lignin and the lignin oligomer used are dissolved into the aqueous composition.

The temperature can be controlled during the production of the binder composition by cooling and/or heating the aqueous composition.

In one embodiment, step (i) comprises mixing lignin oligomer with the aqueous composition before lignin is added thereto. In one embodiment, step (i) comprises mixing lignin and lignin oligomer essentially simultaneously into the aqueous composition.

The aqueous composition in step (ii) may comprise or consist of or consist essentially of the aqueous composition from (i) and the crosslinking agent.

Step (ii) may comprise heating at a temperature of 60-95° C., or 75-90° C., or 70-80° C., or 70-90 ºC. The heating in step (ii) may be continued until a binder composition with a viscosity value of 200-1000 cp, or 250-600 cP, as measured at 25° C. is formed. In one embodiment, step (ii) is continued until a binder composition with a viscosity value of 200-500 cP, or 250-400 cp, or 300-350 cP, is formed. In one embodiment, step (ii) is continued until a binder composition with a viscosity value of 500-1000 cP, or 500-800 cP, or 550-750 cp, or 600-700 cP, is formed.

The viscosity can be measured at a temperature of 25° C. by using a rotary viscometer (Digital Brookfield viscometer LVDV-II+ Pro; cone spindle). In one embodiment, step (ii) is continued for 0.5-8 hours, or 1-6 hours, or 2-5 hours.

Step (ii) may comprise adding catalyst in a stepwise manner. I.e. further amount of catalyst in addition to the what is used in step (i) may be added during step (ii). The addition of the catalyst in a stepwise manner has the added utility of allowing lignin, lignin oligomer and crosslinking agent to polymerize in a controlled manner. In one embodiment, step (ii) comprises adding catalyst in a stepwise manner and heating the formed aqueous composition for polymerizing lignin, lignin oligomer and crosslinking agent in a controlled manner.

In the context of this specification, the term “lignin” may refer to lignin originating from any suitable lignin source. In one embodiment, the lignin is essentially pure lignin. By the expression “essentially pure lignin” should be understood as at least 70% pure lignin, or at least 90% pure lignin, or at least 95% pure lignin, or at least 98% pure lignin. The essentially pure lignin may comprise at most 30%, or at most 10%, or at most 5%, or at most 2%, of other components and/or impurities. Extractives and carbohydrates such as hemicelluloses can be mentioned as examples of such other components.

In one embodiment, the lignin oligomer is essentially pure lignin oligomer. By the expression “essentially pure lignin oligomer” should be understood as at least 70% pure lignin oligomer, or at least 80% pure lignin oligomer, or at least 90% pure lignin oligomer, or at least 95% pure lignin oligomer, or at least 98% pure lignin oligomer. The essentially pure lignin oligomer may comprise at most 30%, or at most 10%, or at most 5%, or at most 2%, of other components and/or impurities.

The lignin may contain less than 30 weight-%, or less than 10 weight-%, or less than 5 weight-%, or less than 3 weight-%, or less than 2.5 weight-%, or less than 2 weight-% of carbohydrates. The lignin oligomer may contain less than 30 weight-%, or less than 10 weight-%, or less than 5 weight-%, or less than 3 weight-%, or less than 2.5 weight-%, or less than 2 weight-% of carbohydrates. The amount of carbohydrates present in lignin can be measured by high performance anion exchange chromatography with pulsed amperometric detector (HPAE-PAD) in accordance with standard SCAN-CM 71.

The ash percentage of lignin may be less than 7.5 weight-%, or less than 5 weight-%, or less than 3 weight-%, or less than 1.5 weight-%. The ash percentage of lignin oligomer may be less than 15 weight-%, or less than 10 weight-%, or less than 5 weight-%. The ash content can be determined in the following manner: Dry solid content of the sample is determined first in an oven at 105° ° C. for 3 h. Ceramic crucibles are pre-heated to 700° C. for 1 hour and weight after cooling. A sample (1.5 g-2.5 g) is weighted into a ceramic crucible. The crucible with a lip is put into a cold oven. Temperature of the oven is raised: 20-200° C., 30 min=>200-600° C., 60 min=>600-700° C., 60 min. Burning is continued without the lid at 700° C. for 60 min. The crucible is let to cool in desiccator and few drops of hydrogen peroxide (H₂O₂, 30%) is added to the sample followed by burning in the oven at 700° C. for 30 minutes. If there are still dark spots in the ash, the hydrogen peroxide treatment and burning is repeated. The crucible is cooled down and weighted. All weigh-in is done with a precision of 0.1 mg and after cooling in a desiccator.

### Calculation of the Results

Ash content %=(100a×100)/(b×c)

wherein
a=weight of the ash, g
b=weight of the sample, g
c=dry solids of the sample, %
   Ash content of a sample refers to the mass that remains of the sample after burning and annealing, and it is presented as percentage of the sample's dry content.

Ash content of a sample refers to the mass that remains of the sample after burning and annealing, and it is presented as percentage of the sample's dry content.

The lignin used for preparing the binder composition may be selected from a group consisting of kraft lignin, steam explosion lignin, biorefinery lignin, supercritical separation lignin, hydrolysis lignin, flash precipitated lignin, biomass originating lignin, lignin from alkaline pulping process, lignin from soda process, lignin from organosolv pulping, lignin from alkali process, lignin from enzymatic hydrolysis process, and any combination thereof. In one embodiment, the lignin is wood based lignin. The lignin can originate from softwood, hardwood, annual plants or from any combination thereof.

By “kraft lignin” is to be understood in this specification, unless otherwise stated, lignin that originates from kraft black liquor. Black liquor is an alkaline aqueous solution of lignin residues, hemicellulose, and inorganic chemicals used in a kraft pulping process. The black liquor from the pulping process comprises components originating from different softwood and hardwood species in various proportions. Lignin can be separated from the black liquor by different, techniques including e.g. precipitation and filtration. Lignin usually begins precipitating at pH values below 11-12. Different pH values can be used in order to precipitate lignin fractions with different properties. These lignin fractions differ from each other by molecular weight distribution, e.g. Mw and Mn, polydispersity, hemicellulose and extractive contents. The molar mass of lignin precipitated at a higher pH value is higher than the molar mass of lignin precipitated at a lower pH value. Further, the molecular weight distribution of lignin fraction precipitated at a lower pH value is wider than of lignin fraction precipitated at a higher pH value. The precipitated lignin can be purified from inorganic impurities, hemicellulose and wood extractives using acidic washing steps. Further purification can be achieved by filtration.

The term “flash precipitated lignin” should be understood in this specification as lignin that has been precipitated from black liquor in a continuous process by decreasing the pH of a black liquor flow, under the influence of an over pressure of 200-1000 kPa, down to the precipitation level of lignin using a carbon dioxide based acidifying agent, preferably carbon dioxide, and by suddenly releasing the pressure for precipitating lignin. The method for producing flash precipitated lignin is disclosed in patent application FI 20106073. The residence time in the above method is under 300 s. The flash precipitated lignin particles, having a particle diameter of less than 2 μm, form agglomerates, which can be separated from black liquor using e.g. filtration. The advantage of the flash precipitated lignin is its higher reactivity compared to normal kraft lignin. The flash precipitated lignin can be purified and/or activated if needed for the further processing.

The lignin may be derived from an alkali process. The alkali process can begin with liquidizing biomass with strong alkali followed by a neutralization process. After the alkali treatment, the lignin can be precipitated in a similar manner as presented above.

The lignin may be derived from steam explosion. Steam explosion is a pulping and extraction technique that can be applied to wood and other fibrous organic material.

By “biorefinery lignin” is to be understood in this specification, unless otherwise stated, lignin that can be recovered from a refining facility or process where biomass is converted into fuel, chemicals and other materials.

By “supercritical separation lignin” is to be understood in this specification, unless otherwise stated, lignin that can be recovered from biomass using supercritical fluid separation or extraction technique. Supercritical conditions correspond to the temperature and pressure above the critical point for a given substance. In supercritical conditions, distinct liquid and gas phases do not exist. Supercritical water or liquid extraction is a method of decomposing and converting biomass into cellulosic sugar by employing water or liquid under supercritical conditions. The water or liquid, acting as a solvent, extracts sugars from cellulose plant matter and lignin remains as a solid particle.

The lignin may be derived from a hydrolysis process. The lignin derived from the hydrolysis process can be recovered from paper-pulp or wood-chemical processes.

The lignin may originate from an organosolv process. Organosolv is a pulping technique that uses an organic solvent to solubilize lignin and hemicellulose.

In one embodiment, the lignin consists of softwood Kraft lignin. In one embodiment, the lignin is softwood Kraft lignin having a weight average molecular weight (Mw) of 2700-9000 g/mol, or 3000-8000 g/mol, or 3500-7000 g/mol.

In one embodiment, the lignin has a weight average molecular weight of 3000-8000 g/mol, or 3500-7000 g/mol. The lignin, e.g. the Kraft lignin, may have a polydispersity index of 2.9-6.0, or 3.0-5.0, or 3.2-4.5.

In one embodiment, the lignin is a combination of softwood lignin and hardwood lignin. In one embodiment, at most 30 weight-, or at most 25 weight-%, or at most 10 weight-s, or at most 5 weight-% of the lignin originates from hardwood.

The weight average molecular weight may be determined by using gel permeation chromatography (GPC) equipped with UV detector (280 nm) in the following manner: A sample is dissolved into 0.1 M NaOH. The sample solution is filtered with 0.45 micron PTFE filter. The measurement is performed in 0.1 M NaOH eluent (0.5 ml/min, T=30° C.) using PSS MCX precolumn, 1000 Å and 100 000 Å columns, with sulfonated styrene-divinylbenzene copolymer matrix. The molecular weight distribution of the sample is calculated in relation to Na-polystyrene sulfonate standards (6 pieces) Mw 891-65400. Values Mw (weight average molecular weight) and Mn (number average molecular weight), polydispersity index (PDI, Mw/Mn) are reported based on two parallel measurements.

The amount of alkali insoluble matter of the softwood Kraft lignin may be below 10%, or below 5%, or below 0.5%. The amount of alkali insoluble matter may be determined in the following manner: Dry solid content of the sample is determined first in an oven at 105° ° C. for 3 h. 100 g of sample is dissolved into 277 g NaOH-water solution (pH 12-13) at mixed at 50-60° C. for 30 min. Solution is filtrated with a Büchner funnel through a glass filter. The residue on the filter is washed with 0.1M NaOH and finally with water. The filter with the residue is dried in an oven and then weighted. The amount of alkali insoluble matter is then calculated as follows:

Alkali insoluble matter,%=[weight of the filter with residue(dryed) (g)−weight of the filter]/[weight of the sample (g)*dry solid content of the samples (%)]

The amount of condensed and syringul groups of softwood Kraft lignin may be below 3.0 mmol/g, or 2.5 mmol/g, or below 2.0 mmol/g when determined with 31P NMR. The amount of aliphatic OH groups of softwood Kraft lignin may be below 3.0 mmol/g, or below 2.5 mmol/g when determined with 31P NMR. The amount of Guaiacyl OH of softwood Kraft lignin may be at least 1.5 mmol/g when determined with 31P NMR.

The measurements conducted with 31P NMR spectroscopy after phosphitylation can be used for quantitative determination of functional groups (aliphatic and phenolic hydroxyl groups, and carboxylic acid groups). Sample preparation and measurement are performed according to method by Granata and Argyropoulos (Granata, A., Argyropoulos, D., J. Agric. Food Chem. 1995, 43:1538-1544). Accurately weighted sample (˜25 mg) is dissolved in N, N-dimethylformamide, and mixed with pyridine and internal standard solution (ISTD) endo-N-Hydroxy-5-norbornene-2,3-dicarboximide (e-HNDI). Phosphitylation reagent (200 μl) 2-chloro-4,4,5,5-tetramethyl-1,3,2-dioxaphopholane is added slowly, and finally a 300 μl CDCl₃ is added. NMR measurements are performed immediately after addition of the reagent. Spectra are measured with spectrometer, equipped with a broadband detection optimized probehead.

In one embodiment, the lignin oligomer is softwood lignin oligomer having a weight average molecular weight of 800-2500 g/mol. In one embodiment, the lignin oligomer has a weight average molecular weight of 1200-2400 g/mol, or 1400-2300 g/mol. The oligomer lignin may have a polydispersity index of 2.8-1.0, or 2.6-1.3, or 2.4-1.5.

Lignin may be de-polymerized for reducing the molecular weight of the polymer in order to form low molecular weight lignin oligomers. The activity and reactivity may simultaneously be increased.

Lignin oligomers can thus be produced by decomposition of lignin with different technologies based on e.g. thermochemical or enzymatic degradation. The aromatic character of macromolecular lignin is known and the break down strategies such as pyrolysis and hydrogenolytic treatments such as catalytic hydropyrolysis, hydrocracking, hydrothermal upgrading, base catalyzed degradation (BCD), are applicable in industry. Such strategies have the objective to reduce the complexity of the molecule, to increase the chemical reactivity of the degradation products and to increase the number of the degrees of freedom for chemical reactions. However, in all cases such simple monomer structures (e.g. benzene, phenol, catechol, and pyrogallol from the lignin) are not the main products of the break down processes. Generally, two fractions will be formed, monomeric and oligomeric. Side products are e.g. formic acid, acetic acid, methanol and carbon dioxide.

The base catalyzed degradation process (BCD) is a more selective cleavage process compared to other lignin degradation processes and needs no additional hydrogen. The degradation is based on a catalyzed cleavage of the aryl-aryl-ether bonds (α-O-4, β-O-4, 4-O-5) by strong bases (e.g. sodium hydroxide) in hot compressed water (sub- and near-critical conditions, T=250-350° C.). Also processing in milder conditions is applicable. The cleavage process is realizable for example in a batch reactor, a continuously stirred tank reactor (CSTR) or in a plug-flow reactor (PER). The process parameters (e.g. T, t, p, t, additives, catalyst) can be adjusted to steer the reactions and cleavage of methyl-aryl-ether bonds. By adjusting these parameters the lignin oligomer yield and the weight average molecular weight of the lignin oligomer fraction can be adjusted and optimized to the desired level. Downstream processes e.g. precipitation, filtration, liquid/liquid extraction, evaporation, are for the generation of the oligomeric lignin fractions. The oligomer rich phase is a solid material.

The precise order of combining and/or adding the components needed for the binder composition production may vary depending e.g. on the required properties of the formed binder composition. The choice of the sequence of combining and/or adding the required components is within the knowledge of the skilled person based on this specification. The precise amount of the components used for producing the binder composition may vary and the choice of the amounts of the different components is within the knowledge of the skilled person based on this specification.

Further is disclosed an adhesive composition comprising the binder composition as disclosed in the current specification. The adhesive composition can, in addition to the binder composition, comprise one or more adhesive components selected from a group consisting of other binders, extenders, additives, catalysts and fillers. A binder is a substance, which is mainly responsible for creating the growing and crosslinking of polymer and thus assists in the curing of polymer systems. An extender is a substance, which assists the binder by adjusting physical properties for example by binding moisture. The additive can be a polymer or an inorganic compound, which assists in properties like filling, softening, reducing costs, adjusting moisture, increasing stiffness and increasing flexibility. The catalyst is a substance, which usually boosts and adjusts the curing speed. By “substance” is herein to be understood as including a compound or a composition. The binder composition may serve as a binder, an extender, an additive, a catalyst and/or a filler in the adhesive composition.

The binder composition as well as the adhesive composition may be used for gluing a wood product. In one embodiment, the wood product is selected from a group consisting of a wood board, a wood veneer, and a wood bar.

The method as disclosed in the current specification has the added utility of enabling the production of a binder composition without the use of e.g. phenol, or any other compound selected from the class of phenols. The method as disclosed in the current specification has the added utility of enabling the production of a phenol-free binder composition having suitable properties, such a weight average molecular weight and viscosity, for industrial applications. Further, the binder composition as disclosed in the current specification has the added utility of providing water resistant, stabile adhesion and/or low formaldehyde emissions for the end product produced by using said binder composition.

### EXAMPLES

Reference will now be made in detail to various embodiments.

The description below discloses some embodiments in such a detail that a person skilled in the art is able to utilize the embodiments based on the disclosure. Not all steps or features of the embodiments are discussed in detail, as many of the steps or features will be obvious for the person skilled in the art based on this specification.

### Example 1—Preparing a Binder Composition

In this example a lignin-lignin oligomer-formaldehyde binder composition was produced.

The following components and their amounts were used:

| | | |
|---|---|---|
| water I 100% | 1025 | kg |
| NaOH (I part) 50% | 400 | kg |
| kraft lignin 66.3% | 1050 | kg |
| (Mw = 5100 g/mol) | | |
| lignin oligomer 97% | 180 | kg |
| (Mw = 1890 g/mol) | | |
| NaOH (II part) 50% | 160 | kg |
| formaldehyde 37.5% | 630 | kg |

The percentages of the components (based on total dry matter content) used in this example were the following:

| | |
|---|---|
| NaOH 50% | 8.1% |
| kraft lignin 66.3% | 20.2% |
| lignin oligomer 97% | 5.1% |
| formaldehyde 37.5% | 6.9% |

The molar ratio of NaOH to lignin and lignin oligomer was 1.45. The molar ratio of formaldehyde to lignin and lignin oligomer was 1.63.

Firstly, water and the first part of NaOH were mixed at room temperature and heating of the same was started. When the temperature reached 75° C., lignin oligomer and lignin were added to the aqueous composition. Mixing and heating was continued while keeping the temperature at about 90° C. for about 30 minutes. Then the temperature of the aqueous composition was allowed to cool to about 60 ºC, the formaldehyde were added.

Mixing and heating of the formed aqueous composition was continued for 30 minutes, part of the NaOH was added and again mixing and heating was continued for 30 minutes and then the last part of the NaOH was added. Mixing and heating of the formed composition was continued for about one hour while keeping the temperature at about 75 ºC. The viscosity of the formed composition was 570 cP (as measured at 25) ° ° C.

The formed binder composition had the following measured properties:

| | |
|---|---|
| Solids, % | 35.7 |
| | (3 hours at 105° C.) |
| pH | 12.5 |
| Viscosity, cp | 620 |
| | (at 25° C., after 3 days) |
| Alkalinity, % | 5.55 |
| Free formaldehyde, % | 0.11 |

### Example 2—Preparing a Binder Composition

In this example a lignin-lignin oligomer-formaldehyde binder composition was produced.

The following components and their amounts were used:

| | | |
|---|---|---|
| water I 100% | 675 | kg |
| NaOH (I part) 50% | 190 | kg |
| kraft lignin 69.6% | 655 | kg |
| (Mw = 3900 g/mol) | | |
| lignin oligomer 97% | 120 | kg |
| (Mw = 2100 g/mol) | | |
| NaOH (II part) 50% | 135 | kg |
| formaldehyde 37.5% | 330 | kg |

The percentages of the components (based on total weight) used in this example were the following:

| | |
|---|---|
| NaOH) 50% | 7.7% |
| kraft lignin 66.3% | 21.7% |
| lignin oligomer 97% | 5.5% |
| formaldehyde 37.5% | 5.9% |

The molar ratio of NaOH to lignin and lignin oligomer was 1.3. The molar ratio of formaldehyde to lignin and lignin oligomer was 1.30.

Firstly, water and the first part of NaOH were mixed at room temperature and heating of the same was started. When the temperature reached 75° C., lignin oligomer and lignin were added to the aqueous composition. Mixing and heating was continued while keeping the temperature at about 90° C. for about 30 minutes. Then the temperature of the aqueous composition was allowed to cool to about 60 ºC, the formaldehyde were added.

Mixing and heating of the formed aqueous composition was continued for 30 minutes, the part of the NaOH I was added and again mixing and heating was continued for 60 minutes and then the part of the NaOH II was added. Mixing and heating of the formed composition was continued for about 45 minutes while keeping the temperature at about 70° C. The viscosity of the formed composition was 720 cP (as measured at 25° C.).

The formed binder composition had the following measured properties:

| | |
|---|---|
| Solids, % | 37.1 |
| | (3 hours at 105° C.) |
| pH | 12.6 |
| Viscosity, cp | 860 |
| | (at 25° C., after 3 days) |
| Alkalinity, % | 5.7 |
| Free formaldehyde, % | 0.04 |

### Example 3—Producing a Plywood Product

The binder composition produced in example 2 was used to produce an adhesive composition. The adhesive composition was formed by mixing binder composition with wheat flour and limestone (1:1) to arrive to the target viscosity of 70-100 second FC 6 mm at 25° C. In the adhesive composition 3% of sodium carbonate was used a hardener.

The formed adhesive composition was then used to produce a plywood product of birch veneers. The birch veneers having the thickness of 1.5 mm were joined together by the adhesive composition for forming 4.5 mm thick plywood panels. The dry matter content of the adhesive composition was between 35 and 50%. The wood veneers with the adhesive composition were pressed by hot-pressing technique at a temperature between 130-170° C. The adhesive composition was simultaneously cured. The adhesive composition was found suitable for gluing wood veneers together and thus for manufacturing plywood. Results showed that the gluing effect of the adhesive composition was sufficiently good for gluing wood veneers fulfilling the requirements of Bonding class 3 according to EN 314-1 and EN 314-2 standard and formaldehyde emission class—E1 measured according to EN ISO 12460-3.

TABLE 1
Measurement results

| Shear | | Shear | | Formaldehyde |
|---|---|---|---|---|
| strength, | Wood | strength, | Wood | emissions |
| N/mm2 EN | failure, % | N/mm2 EN | failure, % | mg/m2*h EN |
| 314-1, | EN 314-1, | 314-1 | EN 314-1, | ISO 12460-3 |
| pretreatment | pretreatment | pretreatment | pretreatment | |
| 5.1.1 | 5.1.1 | 5.1.3 | 5.1.3 | |
| 1.12 | 65 | 0.75 | 67 | 0.06 |

It is obvious to a person skilled in the art that with the advancement of technology, the basic idea may be implemented in various ways. The embodiments are thus not limited to the examples described above; instead they may vary within the scope of the claims.

The embodiments described hereinbefore may be used in any combination with each other. Several of the embodiments may be combined together to form a further embodiment. A method, a binder composition, an adhesive composition, or the uses, disclosed herein, may comprise at least one of the embodiments described hereinbefore. It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items. The term “comprising” is used in this specification to mean including the feature (s) or act (s) followed thereafter, without excluding the presence of one or more additional features or acts.

1. A method for producing a binder composition without using a compound selected from the class of phenols, wherein the method comprises:
(i) heating an aqueous composition comprising lignin having a weight average molecular weight (Mw) of 2700-9000 g/mol and lignin oligomer having a weight average molecular weight (Mw) of 800-2500 g/mol in the presence of a catalyst at a temperature of 50-95° C. for 0.25-5 hours; and
(ii) mixing a crosslinking agent with the aqueous composition from (i) and heating the same at a temperature of 60-95° C. for polymerizing lignin, lignin oligomers, and crosslinking agent until a binder composition with a predetermined viscosity value is formed,
wherein the molar ratio of crosslinking agent to lignin and lignin oligomer is 0.5-1.8.

2. The method of claim 1, wherein the total amount of crosslinking agent used for producing the binder composition is 3-8 weight-%, based on the total weight of the binder composition.

3. The method of claim 1, wherein the molar ratio of crosslinking agent to lignin and lignin oligomer is 0.9-1.7.

4. The method of claim 1, wherein the weight ratio of catalyst to lignin and lignin oligomer is 0.20-0.37.

5. The method of claim 1, wherein the weight ratio of lignin oligomer to lignin is 0.05-1.0.

6. The method of claim 1, wherein step (ii) comprises heating at a temperature of 75-90° C.

7. The method of claim 1, wherein the lignin is softwood Kraft lignin having a weight average molecular weight (Mw) of 2700 9000 g/mol.

8. The method of claim 1, wherein the crosslinking agent is an aldehyde prepared from bio-methanol.

9. The method of claim 1, wherein heating in step (ii) is continued until a binder composition with a viscosity value of 200-1000 cp, as measured at 25° C., is formed.

10. A binder composition obtainable by a method comprising:
(i) heating an aqueous composition comprising lignin having a weight average molecular weight (Mw) of 2700-9000 g/mol and lignin oligomer having a weight average molecular weight (Mw) of 800-2500 g/mol in the presence of a catalyst at a temperature of 50-95° C. for 0.25-5 hours; and
(ii) mixing a crosslinking agent with the aqueous composition from (i) and heating the same at a temperature of 60-95° C. for polymerizing lignin, lignin oligomers, and crosslinking agent until a binder composition with a predetermined viscosity value is formed,
wherein the molar ratio of crosslinking agent to lignin and lignin oligomer is 0.5-1.8.

11. An adhesive composition comprising the binder composition of claim 10.

12. The binder composition of claim 10, wherein the binder composition is configured to be used in an impregnation application, for gluing a wood product or layered wood product or wood panel, for producing a laminate, shuttering film, mineral wool, nonwoven fiber product, molded fiber product, or extruded fiber product.

13. A product comprising:
a binder composition obtained by the method comprising (i) heating an aqueous composition comprising lignin having a weight average molecular weight (Mw) of 2700-9000 g/mol and lignin oligomer having a weight average molecular weight (Mw) of 800-2500 g/mol in the presence of a catalyst at a temperature of 50-95° C. for 0.25-5 hours, and (ii) mixing a crosslinking agent with the aqueous composition from (i) and heating the same at a temperature of 60-95° C. for polymerizing lignin, lignin oligomers, and crosslinking agent until a binder composition with a predetermined viscosity value is formed, wherein the molar ratio of crosslinking agent to lignin and lignin oligomer is 0.5-1.8,
wherein the product has one or more of the following properties:
the amount of formaldehyde emissions being 0.01-0.5 mg/l, when measured by desiccator method EN ISO 12460-4,
the amount of formaldehyde emissions being 0.01-0.40 mg/m2*h, when measured by gas analysis EN ISO 12460-3, and
fulfilling the minimum bonding class 1-4, when measured by bonding quality test method EN 314-1 & EN314-2.
